(19) United States
(12) Patent Application Publication
(10) Pub. No.: US 2015/0073914 A1
(43) Pub. Date: Mar. 12, 2015

(54) PLAYING METHOD AND ELECTRONIC APPARATUS INFORMATION

(71) Applicant: UTECHZONE CO., LTD., New Taipei City (TW)

(72) Inventors: Chia-Chun Tsou, New Taipei City (TW); Yi-Fan Chen, New Taipei City (TW); Chieh-Yu Lin, New Taipei City (TW)

(73) Assignee: UTECHZONE CO., LTD., New Taipei City (TW)

(21) Appl. No.: 14/156,482

(22) Filed: Jan. 16, 2014

(30) Foreign Application Priority Data
Sep. 10, 2013 (TW) 102132600

(51) Int. Cl. G06Q 30/02; G06T 7/00

(52) U.S. Cl. CPC G06Q 30/0269; G06T 7/00; G06T 2207/30201
USPC 705/14.66

(57) ABSTRACT

A playing method and an electronic apparatus are provided. The method includes analyzing an image captured from an image capturing unit to detect whether the image includes a body image; when the image including the body image is detected, calculating a relative distance between the body image and a display unit; when the relative distance is less than or equal to a preset distance, playing a special effect object in the display unit; and transforming a dynamic effect of the special effect object according to a movement information of the body image.

### CROSS-REFERENCE TO RELATED APPLICATION

This application claims the priority benefit of Taiwan application serial no. 102132600, filed on Sep. 10, 2013. The entirety of the above-mentioned patent application is hereby incorporated by reference herein and made a part of this specification.

### BACKGROUND OF THE INVENTION

1. Field of the Invention

The invention relates to a method and an apparatus for controlling display content, and more particularly to a playing method and an electronic apparatus to draw attentions from passers.

2. Description of Related Art

With improvement in technology, stores or vendors may pass advertising information through an electronic advertisement broadcasting apparatus to promote new products or improve visibility of the stores and products. Generally, in a traditional playing method in advertising and marketing model, advertisements and their playing order are preset in the electronic advertisement broadcasting apparatus, so that the electronic advertisement broadcasting apparatus can play the advertisements repeatedly according to the playing order. However, the traditional playing method is of a passive type, and incapable of predicting whether passers will stay in front electronic advertisement broadcasting apparatus for viewing.

### SUMMARY OF THE INVENTION

The invention is directed to a playing method and an electronic apparatus to draw attentions from passers.

The playing method of the invention is adapted to an electronic apparatus. The method includes: analyzing an image captured from an image capturing unit to detect whether the image includes a body image; when the image including the body image is detected, calculating a relative distance between the body image and a display unit; when the relative distance is less than or equal to a preset distance, playing a special effect object in the display unit; and transforming a dynamic effect of the special effect object according to a movement information of the body image.

In an embodiment of the invention, when the image includes the body image, the method further includes: analyzing one of a body region, a hand region and a foot region in the body image to obtain a first analyzed result.

In an embodiment of the invention, when the image includes the body image, the method further includes: obtaining a blob image corresponding to a face portion of the body image; analyzing the blob image to obtain a second analyzed result; inquiring a database to correspondingly obtain a play category according to at least one of the first analyzed result and the second analyzed result; and playing a multimedia information corresponding to the play category in the display unit. When the relative distance is less than or equal to the preset distance, the multimedia information and the special effect object are displayed together in the display unit. The first analyzed result includes at least one of a height and a body movement, and the second analyzed result includes at least one of a gender, an age and a number of persons.

In an embodiment of the invention, before obtaining the blob image corresponding to the face portion of the body image, the method further includes: detecting whether the face portion of the body image faces the display unit, and when the face portion facing the display unit is detected, obtaining the blob image corresponding to the face portion of the body image.

In an embodiment of the invention, after detecting the whether the face portion of the body image faces the display unit, the method further includes: when the face portion facing the display unit is detected, counting a staying time of the face portion facing the display unit; and when the staying time exceeds a preset time, analyzing the blob image to obtain the second analyzed result.

In an embodiment of the invention, the step of analyzing the blob image includes: analyzing an eye region having an eye portion in the blob image to determine whether the eye portion stares at the display unit; when the eye portion staring at the display unit is determined, counting a staring time of the eye portion staring the display unit; and recording the staring time, the multimedia information currently played, and a feature information of the face portion.

In an embodiment of the invention, the method further includes: when the image includes a plurality of persons, obtaining the blob image corresponding to the face portion of the body image for each of the persons; and analyzing the blob image for each of the persons and executing statistics calculation for the second analyzed result of each of the persons to obtain a statistical analyzed result.

In an embodiment of the invention, when the image includes the persons, the method further includes: calculating a first number of the persons with the face portion facing the display unit; calculating a second number of the persons with the face portion not facing the display unit; and calculating a proportion according to the first number and the second number.

In an embodiment of the invention, the step of inquiring the database to correspondingly obtain the play category includes: determining whether face portion is already recorded in the electronic apparatus according to a feature information of the face portion; and if the face portion is already recorded in the electronic apparatus, playing the multimedia information corresponding to the face portion according to a related playing content being previously recorded.

In an embodiment of the invention, the multimedia information includes at least one of a video, a picture and a text content. The special effect object includes at least one of a dynamic special effect and a sound effect.

An electronic apparatus of the invention includes a display unit, a storage unit, a first image capturing unit and a processing unit. The storage unit includes a first database, and the first database is configured to store a plurality of special effect objects. The first image capturing unit is configured to capture an image having a depth information. The processing unit is coupled to the display unit, the storage unit and the first image capturing unit. The processing unit executes the image analysis module to analyze the image captured from the first image capturing unit. The image analysis module detects whether the image includes a body image. When the image including the body image is detected, calculating a relative distance between the body image and a display unit according to the depth information. When the relative distance is less than or equal to a preset distance, one of the special effect objects is selected from the first database, and the selected special effect object is played in the display unit. The image analysis module transforms the dynamic effect of the special effect object displayed in the display unit according to a movement information of the body image.

In an embodiment of the invention, the image analysis module includes: a human detection module configured to detect whether the image includes a body image; a distance estimation module configured to calculate the relative distance between the body image and the display unit when the human detection module detects that the image includes the body image; a movement tracing module configured to trace a movement of the body image to obtain the movement information; and a special effect control module configured to select one of the special effect objects from the first database, play the selected special effect object in the display unit when the relative distance is less than or equal to the preset distance, and transform the dynamic effect of the special effect object displayed in the display unit according to the movement information of the body image.

In an embodiment of the invention, when the human detection module detects that the image includes the body image, the movement tracing module can further analyze one of the body region, the hand region and the foot region in the body image to obtain a first analyzed result.

In an embodiment of the invention, the electronic apparatus further includes a second image capturing unit configured to capture an image having a color information. The storage unit further includes: a second database configured to store a plurality of multimedia information; and a third database configured to store a plurality of play categories, and each of the play categories is related to at least one of the multimedia information. In addition, the image analysis module further includes: a face recognition module configured to obtain a blob image corresponding to the face portion according to the image having the color information captured from the second image capturing unit when a face portion of the body image facing the display unit is detected; a feature analysis module configured to analyze the blob image to obtain a second analyzed result; and a multimedia control module configured to correspondingly obtain one of the play categories from the second database, so as to obtain one of the multimedia information from the third database accordingly, thereby playing the obtained multimedia information in the display unit.

Based on above, when it is detected that the passer approaches the display unit, the special effect object are played in the display unit, and the dynamic effect of the special object is transformed according to the movement of the passer, so as to draw attention from the passer.

To make the above features and advantages of the disclosure more comprehensible, several embodiments accompanied with drawings are described in detail as follows.

### BRIEF DESCRIPTION OF THE DRAWINGS

FIG. 1 is a block diagram of an electronic apparatus according to first embodiment of the invention.

FIG. 2A is a schematic diagram for disposing an image capturing unit according to first embodiment of the invention.

FIG. 2B is a top view for capturing images according to first embodiment of the invention.

FIG. 3 is a flowchart of a playing method according to the first embodiment of the invention.

FIG. 4 is a block diagram of an electronic apparatus according to second embodiment of the invention.

FIG. 5 is a block diagram of an image analysis module apparatus according to second embodiment of the invention.

FIG. 6 is a flowchart of a playing method according to the second embodiment of the invention.

### DESCRIPTION OF THE EMBODIMENTS

Generally, a traditional electronic advertisement is repeatedly played according to a specific playing order, which cannot ensure to attract passers to stay for viewing. Accordingly, the invention proposes a playing method and an electronic apparatus to draw attentions from the passers and improve a visibility of a playing content thereof. In order to make the invention more comprehensible, embodiments are described below as the examples to prove that the invention can actually be realized.

### First Embodiment

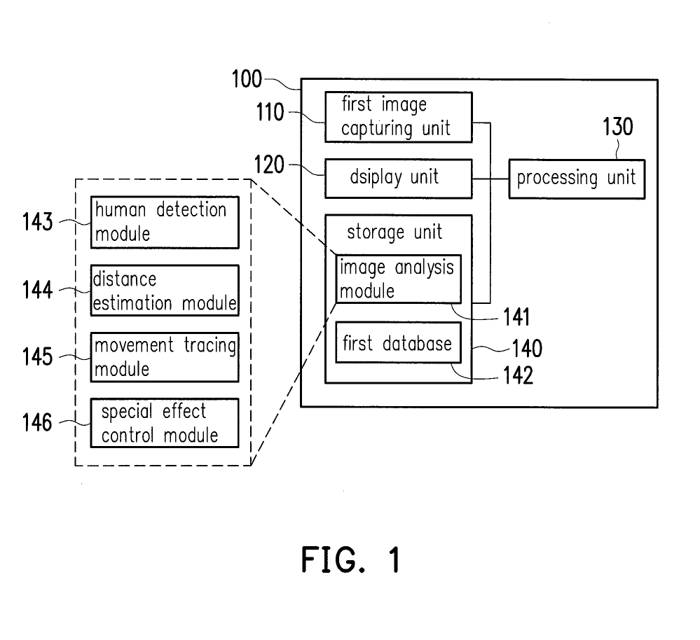

FIG. 1 is a block diagram of an electronic apparatus according to first embodiment of the invention. Referring to FIG. 1, an electronic apparatus 100 includes a first image capturing unit 110, a display unit 120, a processing unit 130 and a storage unit 140. The processing unit 130 is coupled to the first image capturing unit 110, the display unit 120 and the storage unit 140, respectively.

The first image capturing unit 110 is configured to capture an image having a depth information within a capturing range. In the present embodiment, the first image capturing unit 110 is, for example, a depth camera or a 3D camera, and disposed at a position where images in front of the display unit 120 can be captured. For instance, the first image capturing unit 110 can be installed near the display unit 120, or on a ceiling at an appropriate place, but the invention is not limited thereto.

The display device 120 is, for example, a liquid-crystal display (LCD), a plasma display, a vacuum fluorescent display, a light-emitting diode (LED) display, a field emission display (FED) and/or other appropriate displays, but a type of the display device is not limited in the invention.

The processing unit 130 is, for example, a central processing unit (CPU) or other programmable devices for general purpose or special purpose such as a microprocessor, a digital signal processor (DSP), a programmable controller, an application specific integrated circuit (ASIC), a programmable logic device (PLD) or other similar devices or a combination of above-mentioned devices.

The storage unit 140 is, for example, a fixed or a movable device in any possible forms including a random access memory (RAM), a read-only memory (ROM), a flash memory, a hard drive or other similar devices, or a combination of the above-mentioned devices. The storage unit 140 includes an image analysis module 141 and a first database 142.

The image analysis module 141 is, for example, a program code segment written by a computer programming language, and the program code segment includes a plurality of commands. The playing method can be implemented by using the processing unit 130 to execute the program code segment. The processing unit 130 executes the image analysis module 141 to analyze the image captured from the first image capturing unit 110. The first database 142 is configured to store a plurality of special effect objects. The special effect objects include a dynamic special effect, a sound effect and a combination thereof. The dynamic special effect can be, for example, a blooming flower, a moving ribbon, an exploding object, a thrown object, a moving doll, and so on.

After the image is obtained by the image analysis module 141, a background removing operation can first be performed thereto. Namely, stationary objects in the image are filtered out, and the stationary object may be a background object such as a signboard, a statue, a bus stop, or a building and so on. More specifically, the image analysis module 141 can include a human detection module 143, a distance estimation module 144, a movement tracing module 145 and a special effect control module 146. Descriptions for each of said modules are provided below.

The human detection module 143 is configured to detect whether the image includes a body image. Namely, whether the capturing range includes a person is determined. For instance, after a plurality of feature values are obtained by the human detection module 143 from the image having the depth information, the feature values are compared with preset feature values to determine whether the capturing range includes the person.

More specifically, the feature values for various body images are established in advance and stored in the storage unit 140. The feature values for various body images include, for example, a relative position of a head region and a hand region (e.g., the hand is located below the head), a symmetric relation of the hand portion in relative to a body region (e.g., the hand is respectively provided at left and right sides of the body), a size relation of each body portion (e.g., the body region is bigger than the head portion) and so on. Afterwards, the human detection module 143 locates a blob that belongs to a human body from the image being captured by utilizing a blob detect algorithm. Next, the feature values are correspondingly obtained from the blob (e.g., the feature values including the head portion, the hand region, the body region and so on), and the feature values being obtained are compared with the feature values being established in advance. In case the feature values being obtained are matched to the feature values being established in advance, it indicates that the blob is the body image.

The distance estimation module 144 calculates a relative distance between the body image and the display unit 120 when the human detection module 143 detects that the image includes the body image. For instance, the distance estimation module 144 can calculate a distance from a position where a passer is actually located to the display unit 120 according to the depth information.

The movement tracing module 145 obtains a movement information (e.g., a movement direction, a movement trace and so on) by tracing a movement of the body image. For instance, after the body image is obtained by the human detection module 143, a skeletal model is built in the body image for subsequent process according to features such as positions and sizes of the head, the hand and the body. The skeletal model can include a plurality of bone members, and bonding members between adjacent bone members. In addition, the movement tracing module 145 can also determine whether the body image is still included in subsequent images according to a shape, a depth value, a world coordinate value regarding the body image. In addition, when the human detection module 143 detects that the image includes the body image, the movement tracing module 145 can further analyze one of the body region, the hand region and the foot region in the body image to obtain a first analyzed result. The first analyzed result includes a height and a body movement of the passer. The movement tracing module 145 can also obtain a gesture of the passer by recognizing the body movement of the passer, so that the processing unit 130 can perform corresponding operations to a display frame in the display unit 120 according to the gesture being detected.

The special effect control module 146 is configured to select one of the special effect objects from the first database 142, and play the selected special effect object in the display unit 120 when the relative distance is less than or equal to the preset distance (e.g. 3 meters), and transform the dynamic effect of the special effect object displayed in the display unit 120 according to the movement information of the body image.

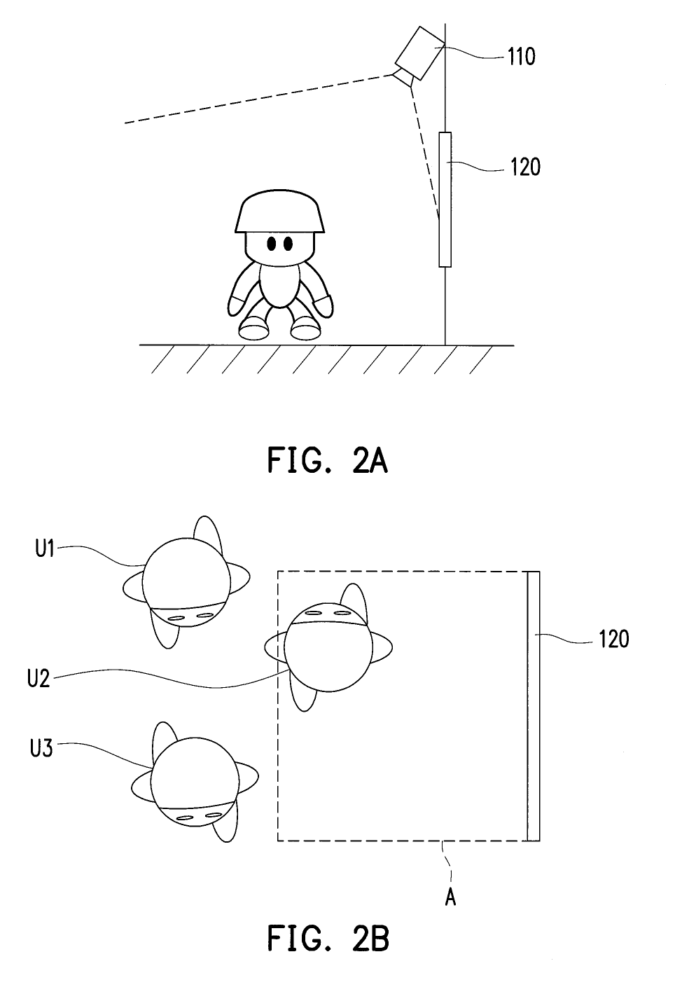

For instance, FIG. 2A is a schematic diagram for disposing an image capturing unit according to first embodiment of the invention. FIG. 2B is a top view for capturing images according to first embodiment of the invention.

In FIG. 2A, the first image capturing unit 110 facing down in a tilted angle, is installed above the display unit 120 to capture images in a top vies. FIG. 2B is a top view in which passers U1 to U3 are provided. The human detection module 143 can detect whether the body image is included in the image having the depth information captured from the first image capturing unit 110. The human detection module 143 is capable of detecting the body images corresponding to the passers U1 to U3. Thereafter, whether each of the body images is located in a detecting area A is further determined. Herein, the detecting area A (herein, it is set as an area within 3 meters in front of the display unit 120) includes the passer U2. Namely, the relative distance between the passer U2 and the display unit 120 is less than 3 meters.

Moreover, in other embodiments, the image analysis module 141 can also be a hardware component composed by one or more circuits, and the hardware component is coupled to the processing unit 130 and driven by the processing unit 130. However, the implementation of the image analysis module 141 is not particularly limited herein.

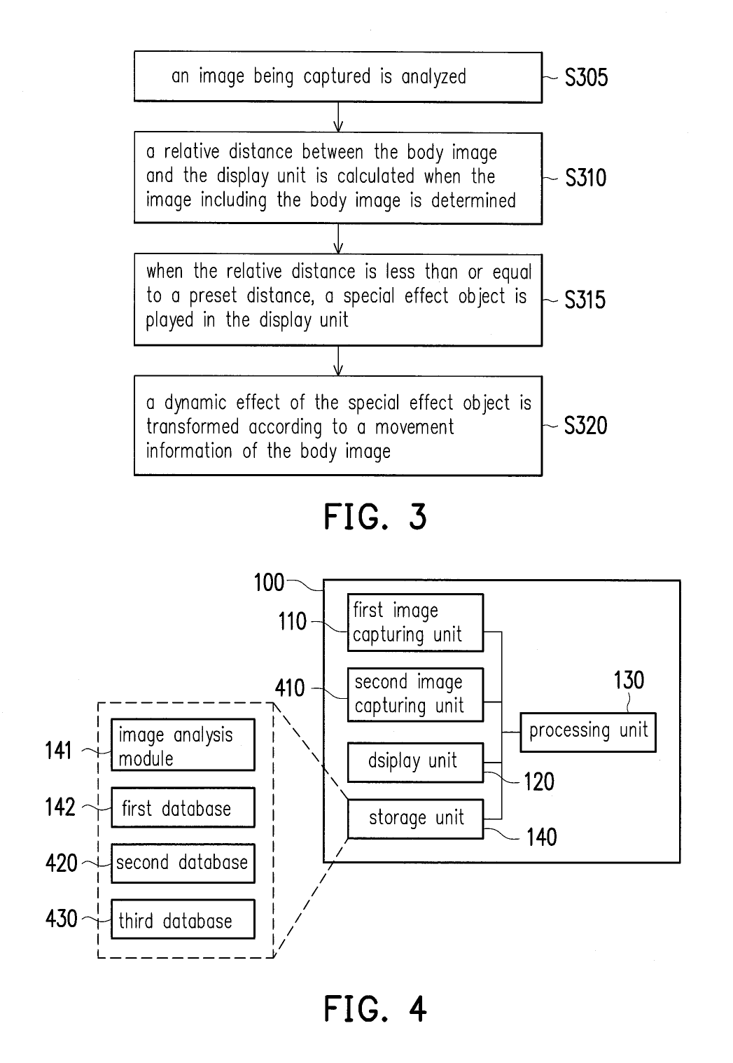

Steps of the playing method are described below with reference to the above-said electronic apparatus 100. FIG. 3 is a flowchart of a playing method according to the first embodiment of the invention. Referring to FIG. 1 and FIG. 3 together, in step S305, the image analysis module 141 analyzes an image captured from the first image capturing unit 110. More specifically, after the image being captured by the first image capturing unit 110 within a capturing range, the image is sent to the processing unit 130 for subsequent analyzing process provided below. First, the human detection module 143 detects whether the image includes the body image. Afterwards, a blob that belongs to a human body are located from the image being captured by utilizing a blob detect algorithm. Next, the feature values are correspondingly obtained from the blob, and the feature values being obtained are compared with the feature values being established in advance. In case the feature values being obtained are matched to the feature values being established in advance, it indicates that the blob is the body image.

Next, in step S310, the distance estimation module 144 calculates a relative distance between the body image and the display unit 120 when it is detected that the image includes the body image.

In step S315, when the relative distance is less than or equal to a preset distance, the special effect control module 146 plays a special effect object in the display unit 120. In case the relative distance is greater than the preset distance, the special effect control module 146 does not play the special effect object in the display unit 120. In other words, the electronic apparatus 100 plays the special effect object that draws attention only when the passers are within a specific range.

In step S320, the special effect module 146 transforms a dynamic effect of the special effect object according to a movement information of the body image. More specifically, the movement tracing module 145 specifically locks the specific body image, and traces the movement of the body image for obtaining the movement information. Thereafter, the special effect control module 146 transforms the dynamic effect of the special effect object according to the movement information. For instance, the special effect object can change its movement direction according to the movement direction of the passer.

For example it is assumed that the passer moves from a left side of the display unit 120 to a right side, and the special effect object is the blooming flow. When it is detected that the passer within the preset distance, an animation in which a flower is changed from a bud into a blooming flower is played at the left side. Next, as the passer moves from left to right, the display unit 120 displays another animation in which a flower is changed from a bud into a blooming flower at places spaced apart for a specific distance with respect to the movement direction of the passer space. Moreover, a proper sound effect can be further played to draw attention from the passer.

In addition, before the special effect object is played, a multimedia information can first be played in the display unit 120. Accordingly, when it is detected that the passer approaches, the multimedia information and the special effect object can both be played in the display unit 120, so that the special effect object can draw attention from the passer.

After the passer is attracted, the multimedia information can be correspondingly played according to a feature information, behaviors and so on. This will be discussed with reference to the following embodiment.

### Second Embodiment

The same reference numbers refer to the same parts in second embodiment and first embodiment, and related descriptions are omitted hereinafter.

FIG. 4 is a block diagram of an electronic apparatus according to second embodiment of the invention. Referring to FIG. 4, an electronic apparatus 100 includes a first image capturing unit 110, a display unit 120, a processing unit 130, a storage unit 140 and a second image capturing unit 410. The processing unit 130 is coupled to the first image capturing unit 110, the second image capturing unit 410, the display unit 120 and the storage unit 140, respectively.

In the present embodiment, the second image capturing unit 410 is further provided. The second image capturing unit 410 may be any camera having a charge coupled device (CCD) lens, a complementary metal oxide semiconductor (CMOS) lens or an infrared lens, and configured to capture an image having a color information.

In addition, besides the first database 120, the storage unit 140 of the present embodiment further includes a second database 420 and a third database 430. Herein, the second database 420 is configured to store a plurality of multimedia information. The multimedia information includes at least one of a video, a picture and a text content. The third database 430 is configured to store a plurality of play categories. Each of the play categories is related to at least one of the multimedia information. In other words, each of the multimedia information is preset to correspond one play category. However, one multimedia information is not limited to only correspond one play category, but also to multiple play categories.

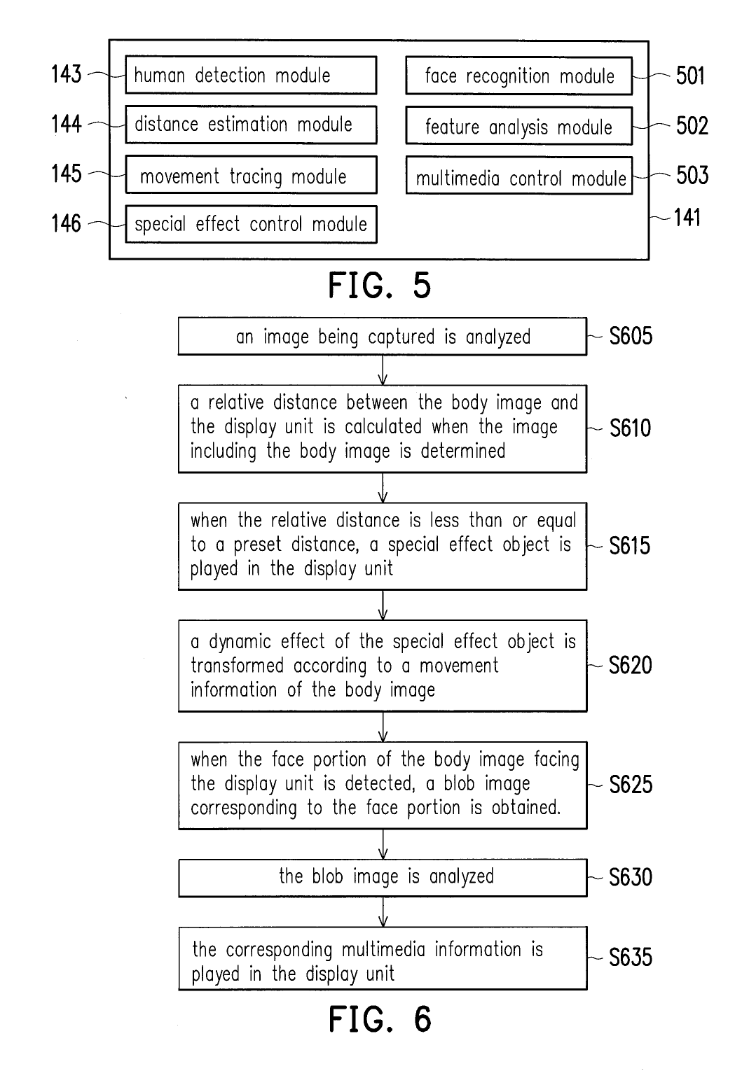

The image analysis module 141 can further include other modules. For instance, FIG. 5 is a block diagram of an image analysis module apparatus according to second embodiment of the invention. In the second embodiment, besides the human detection module 143, the distance estimation module 144, the movement tracing module 145 and the special effect control module 146, the image analysis module 141 further includes a face recognition module 501, a feature analysis module 502 and a multimedia control module 503.

The face recognition module 501 determines whether the image includes a face portion facing the display unit 120 according to the image being captured. For instance, the face recognition module 501 detects whether the image captured from the first image capturing unit 110 includes the face portion through a face recognition algorithm. In case the image includes the face portion, the face recognition module 501 further determines whether the face portion faces the display unit 120. When the face portion of the body image facing the display unit 120 is detected, the face recognition module 501 further obtains a blob image corresponding to the face portion according to the image having the color information captured from the second image capturing unit 410.

The feature analysis module 502 analyzes the blob image (i.e., a face image) from the second image capturing unit 410 to obtain a second analyzed result. For instance, the feature analysis module 502 analyzes the blob image to determine a gender, an age of the corresponding body image, so as to obtain the second analyzed result. In addition, the feature analysis module 502 can further determine a number of persons gathered in front of the display unit 120. Or, the movement tracing module 145 can be used to determine the number of the persons gathered in front of the display unit 120.

The multimedia control module 503 is configured to obtain at least one among the first analyzed result (including the height, the body movement and so on) of the movement tracing module 145 and the second analyzed result (including the gender, the age, the number of persons and so on) of the feature analysis module 502 from the second database 420, so as to correspondingly obtain one of the multimedia information from the third database 430, thereby playing the multimedia information obtained in the display unit 120.

In actual implementation, a plurality of lists can be established in the third database 430, and each of the lists corresponds one play category, and records one or more multimedia information. For instance, the third database 430 includes lists A1 to A3. After the play category A1 is obtained according to the analyzed results, the multimedia control module 503 can then automatically select one of the multimedia information from the list A1 corresponding to the play category A1, and obtain the multimedia information from the second database 420 to be displayed in the display unit 120.

Detailed description of above is provided with reference to FIG. 4 and FIG. 5. FIG. 6 is a flowchart of a playing method according to the second embodiment of the invention. First, steps S605 to S620 identical to steps S305 to S320 of first embodiment are executed. Detailed description regarding steps S605 to S620 can refer to steps S305 to S320 of first embodiment, thus it is omitted hereinafter. Afterwards, the image analysis module 141 can further detect whether a face portion of the body image faces the display unit 120. Next, in step S625, when it is detected that the face portion of the body image faces the display unit 120, a blob image corresponding to the face portion is obtained.

For instance, the image having the color information can be captured by the second image capturing unit 410 only after the image having the depth information captured from the first image capturing unit 110 is analyzed by the human detection module 140 and when it detected that the face portion faces the display unit 120, so that the face recognition module 501 can perform subsequent analysis such as obtaining the blob image corresponding to the face portion from the image having the color information.

In addition, the face recognition module 501 can also directly obtain the image having the color information from the second image capturing unit 410, so as to detect whether there is the face portion that faces the display unit 120. When the face portion of the body image facing the display unit 120 is detected, the face recognition module 501 obtains the blob image corresponding to the face portion from the image having the color information.

In addition, when the face portion of the body image facing the display unit 120 is detected, the movement tracing module 145 can be further utilized to obtain the first analyzed result. For instance, the movement tracing module 145 can analyze feature values of the body region, the hand region and the foot region in the body image, thereby determining the height, the body movement of the body image.

Thereafter, in step S630, the feature analysis module 502 analyzes the blob image to obtain the second analyzed result. For instance, the feature analysis module 502 can determine a gender, an age of the corresponding body image according to the feature values of the blob image.

When the face portion of the body image facing the display unit 120 is detected, the feature analysis module 502 can further count a staying time of the face portion facing the display unit 120. The feature analysis module 502 starts analyzing the blob image only when the staying time exceeds a preset time (e.g., one second), so as to obtain the second analyzed result. If the staying time does not exceed the preset time, the feature analysis module 502 ends the process directly without analyzing the blob image. However, the disclosure is not limited thereto.

Furthermore, the feature analysis module 502 can also analyze an eye region having an eye portion in the blob image to determine whether the eye portion stares at the display unit 120. When it is determined that the eye portion stares at the display unit 120, the feature analysis module 502 counts a staring time of the eye portion staring at the display unit 120, and records the staring time and the feature information of the face portion. In addition, if the display unit 120 is playing the media information, the multimedia information currently played and the corresponding play category are also recorded for subsequent analysis.

Thereafter, in step S635, the multimedia control module 503 obtains the corresponding multimedia information according to above-said analyzed results (e.g., at least one of the gender, the age, the height, the body movement and the number of the persons), and the corresponding multimedia information is played in the display unit 120. For instance, the gender and the age of the passer are detected; in case the passer is a male adult, a car advertisement is played; in case the passer is a female office lady, cosmetics or skin care advertisements are played; and in case the passer is an elder adult, a health product advertisement is played.

For example, it is assumed that the analyzed result being a female, the multimedia control module 503 obtains the corresponding play category from the second database 420, and sequentially or randomly obtains a file name from a “female category list”. Next, the multimedia information corresponding to the file name is then obtained from the third database 430 to be played in the display unit 120.

In addition, the multimedia control module 503 can further determine whether the face portion is recorded in the electronic apparatus 100 according to a feature information of the face portion. If the face portion is already recorded in the electronic apparatus 100, the multimedia control module 503 can then play the multimedia information corresponding to the face portion according to a related playing content being previously recorded. Accordingly, when it is recognized by the face recognition that a user is recorded in the electronic apparatus 100, a content matching the play category that the user is interested in can then be played. For instance, in case the user has been stayed in front the display unit 120 for a number of times, and at the times the multimedia information played by the display unit 120 is a movie advertisement of Sci-Fi (science fiction) movie. Accordingly, when the electronic apparatus 100 detects the user again, the movie advertisement of Sci-Fi movie is then selected to be played.

In addition, it is not limited to only detecting one person in the foregoing embodiment. For instance, when the human detection module 143 detects that the image includes a plurality of persons, the face recognition module 501 can obtain the blob image corresponding to the face portion of the body image for each of the persons. Thereafter, the feature analysis module 502 can analyze the blob image for each of the persons one by one, and executes statistics calculation for the second analyzed result of each of the persons, so as to obtain a statistical analyzed result.

The face recognition module 501 can also calculate a first number of persons with the face portion facing the display unit 120, calculate a second number of the persons with face portion not facing the display unit 120, and calculate a proportion according to the first number and the second number. Accordingly, the number of persons attracted by the special effect object or the multimedia information can be counted.

In addition, the electronic apparatus 100 can further detect a traffic for the persons who stayed for viewing, and a time period for the persons who stayed for viewing. For instance, in case the number of person who stayed for viewing a specific advertisement is particularly increased (e.g., when the number of persons exceeds 10), the electronic apparatus 100 can record the specific advertisement which can be used to further generate an advertisement ranking report for research uses or as a feedback to advertisers.

It should be noted that, after the corresponding multimedia information is played, the movement tracing module 145 can further recognize a gesture of the passer to perform corresponding operations to the multimedia information played in the display unit 120. The corresponding operations include scaling, page turning, rotating and so on.

In summary, in the foregoing embodiments, when it is detected that the passer is approaching the display unit, the special effect object can be played to draw attention from the passer. The foregoing embodiments are adapted to opened public places such as bus stops, stores, department stores. Once attentions of the passers are successfully attracted, active and targeted multimedia information can then be smartly played according to different feature of passers.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A playing method, adapted to an electronic apparatus, comprising:
analyzing an image captured from an image capturing unit to detect whether the image includes a body image;
calculating a relative distance between the body image and a display unit when the image including the body image is detected;
playing a special effect object in the display unit when the relative distance is less than or equal to a preset distance; and
transforming a dynamic effect of the special effect object according to a movement information of the body image.

2. The playing method of claim 1, wherein when the image including the body image is detected, the method further comprising:
analyzing one of a body region, a hand region and a foot region in the body image to obtain a first analyzed result.

3. The playing method of claim 2, wherein when the image including the body image is detected, the method further comprising:
obtaining a blob image corresponding to a face portion of the body image;
analyzing the blob image to obtain a second analyzed result;
inquiring a database to correspondingly obtain a play category according to at least one of the first analyzed result and the second analyzed result; and
playing a multimedia information corresponding to the play category in the display unit, wherein when the relative distance is less than or equal to the preset distance, the multimedia information and the special effect object are displayed together in the display unit.

4. The playing method of claim 3, wherein before obtaining the blob image corresponding to the face portion of the body image, further comprising:
detecting whether the face portion of the body image faces the display unit, and when the face portion facing the display unit is detected, obtaining the blob image corresponding to the face portion of the body image.

5. The playing method of claim 4, wherein after detecting whether the face portion of the body image faces the display unit, further comprising:
counting a staying time of the face portion facing the display unit when the face portion facing the display unit is detected; and
analyzing the blob image to obtain the second analyzed result when the staying time exceeds a preset time.

6. The playing method of claim 3, wherein analyzing the blob image, comprising:
analyzing an eye region having an eye portion in the blob image to determine whether the eye portion stares at the display unit;
counting a staring time of the eye portion staring the display unit when the eye portion staring at the display unit is determined; and
recording the staring time, the multimedia information currently played, and a feature information of the face portion.

7. The playing method of claim 3, further comprising:
obtaining the blob image corresponding to the face portion of the body image for each of a plurality of persons when the image includes the persons; and
analyzing the blob image for each of the persons and executing statistics calculation for the second analyzed result of each of the persons to obtain a statistical analyzed result.

8. The playing method of claim 7, wherein when the image includes the persons, the method further comprising:
calculating a first number of the persons with the face portion facing the display unit;
calculating a second number of the persons with the face portion not facing the display unit; and
calculating a proportion according to the first number and the second number.

9. The playing method of claim 3, wherein inquiring the database to correspondingly obtain the play category, comprising:
determining whether face portion is already recorded in the electronic apparatus according to a feature information of the face portion; and
if the face portion is already recorded in the electronic apparatus, playing the multimedia information corresponding to the face portion according to a related playing content being previously recorded.

10. The playing method of claim 3, wherein the multimedia information include at least one of a video, a picture and a text content.

11. The playing method of claim 3, wherein the first analyzed result includes at least one of a height and a body movement, and the second analyzed result includes at least one of a gender, an age and a number of persons.

12. The playing method of claim 1, wherein the special effect object includes at least one of a dynamic special effect and a sound effect.

13. An electronic apparatus, comprising:
a display unit;
a storage unit, comprising: a first database configured to store a plurality of special effect objects;
a first image capturing unit configured to capture an image having a depth information; and
a processing unit coupled to the display unit, the storage unit and the first image capturing unit, and configured to execute an image analysis module to analyze the image captured from the first image capturing unit;
wherein the image analysis module detects whether the image includes a body image; when the image including the body image is detected, a relative distance between the body image and the display unit is calculated according to the depth information of the image; when the relative distance is less than or equal to a preset distance, one of the special effect objects is selected from the first database, and the selected special effect object is played in the display unit; and a dynamic effect of the special effect object displayed in the display unit is transformed according to a movement information of the body image.

14. The electronic apparatus of claim 13, wherein the image analysis module comprises:
a human detection module configured to detect whether the image includes the body image;
a distance estimation module configured to calculate the relative distance between the body image and the display unit when the human detection module detects that the image includes the body image;
a movement tracing module configured to trace a movement of the body image to obtain the movement information; and
a special effect control module configured to select one of the special effect objects from the first database, play the selected special effect object in the display unit when the relative distance is less than or equal to the preset distance, and transform the dynamic effect of the special effect object displayed in the display unit according to the movement information of the body image.

15. The electronic apparatus of claim 14, wherein when the human detection module detects that the image includes the body image, the movement tracing module analyzes one of a body region, a hand region and a foot region in the body image to obtain a first analyzed result.

16. The electronic apparatus of claim 15, further comprising:
a second image capturing unit configured to capture an image having a color information;
wherein the storage unit further comprises:
a second database configured to store a plurality of multimedia information; and
a third database configured to store a plurality of play categories, wherein each of the play categories is related to at least one of the multimedia information;
the image analysis module further comprising:
a face recognition module configured to obtain a blob image corresponding to the face portion according to the image having the color information captured from the second image capturing unit when a face portion of the body image facing the display unit is detected;
a feature analysis module configured to analyze the blob image to obtain a second analyzed result; and
a multimedia control module configured to correspondingly obtain one of the play categories from the second database according to at least one of the first analyzed result and the second analyzed result, so as to obtain one of the multimedia information from the third database accordingly, thereby playing the obtained multimedia information in the display unit;
wherein when the relative distance is less than or equal to a preset distance, the multimedia information and the special effect object are displayed together in the display unit.

17. The electronic apparatus of claim 16, wherein the face recognition module counts a staying time of the face portion facing the display unit, and informs the feature analysis module to analyze the blob image when the staying time exceeds the preset time.

18. The electronic apparatus of claim 16, wherein the feature analysis module analyzes an eye region having an eye portion in the blob image to determine whether the eye portion stares at the display unit, and counts a staring time of the eye portion staring the display unit when the eye portion staring at the display unit is determined.

19. The electronic apparatus of claim 16, wherein the face recognition module calculates a first number of persons with the face portion facing the display unit, calculates a second number of the persons with face portion not facing the display unit, and calculates a proportion according to the first number and the second number.

20. The electronic apparatus of claim 16, wherein the multimedia information include at least one of a video, a picture and a text content.

21. The electronic apparatus of claim 16, wherein the first analyzed result includes at least one of a height and a body movement, and the second analyzed result includes at least one of a gender, an age and a number of persons.

22. The electronic apparatus of claim 13, wherein the special effect object includes at least one of a dynamic special effect and a sound effect.
